(19) United States
(12) Patent Application Publication
(10) Pub. No.: US 2004/0194727 A1
(43) Pub. Date: Oct. 7, 2004

(54) Solid bird food enclosure

(76) Inventors: Thomas Joseph Conway, Shakopee, MN (US); Dennis James Krampotich, Shakopee, MN (US)

Correspondence Address: Dennis Krampotich, 979 Goldenrod Lane, Shakopee, MN, 55379, US

(21) Appl. No.: 10/408,068

(22) Filed: Apr. 7, 2003

(51) Int. Cl. A01K 13/00

(52) U.S. Cl. 119/600

(57) ABSTRACT

An enclosure with four sides, a top, leaving the bottom side open to allow for insertion and removal of a block of solid bird food. When the block of solid bird food is placed into the enclosure and is retained by a wire cover, the bottom side opening can be large enough to allow the block of solid bird food to freely move within the enclosure. The present invention also relates to an enclosure with four sides, a top, leaving the bottom side open to allow for insertion and removal of a wire basket. When the block of solid bird food is contained in the wire basket that is then inserted into the enclosure, the bottom side opening can be less than the nominal size of the wire basket. This will retain the wire basket in the enclosure.

### FIELD OF THE INVENTION

This invention relates to enclosures. More particularly, it relates to enclosures which aid in preventing unwanted type birds or animals from eating supplied solid bird food and increase the duration that the solid bird food will last

### BACKGROUND OF THE INVENTION

In the past time of bird watching, purchased or made solid bird food is put into a wire basket and hung outside. The said basket allows complete access to the said food for consumption by different types of birds for the purpose of watching the birds consume the said food for human enjoyment. Human enjoyment is reduced or completely lost when unwanted type birds or animals eat the said food or when unwanted and wanted type birds consume the said food too rapidly. In order to reduce unwanted type birds and promote a longer duration for the said food, an enclosure is used with the said basket or independently to limit access and exposure of the said food.

### SUMMARY OF THE INVENTION

The present invention relates to an enclosure with one end open for insertion and removal of a wire basket which holds solid bird food. If the enclosure is used independently from said basket the enclosure will use a wire component attached to the enclosure to retain the said food.

An object and advantage of the invention is that the enclosure may be adjustable to allow a desired amount of exposure of the solid bird food.

A further object and advantage of the invention is that the reduction in exposure to the solid bird food will allow said food to last longer.

A further object and advantage of the invention is that the reduction in exposure to the solid bird food would aid in reduction of unwanted type birds or animals.

### DESCRIPTION OF THE PREFERRED EMBODIMENT

The accompanying drawings, which are incorporated in and constitute a part of the specification, illustrate several aspects of the invention and together with the description serve to explain in detail the principles of the invention. Whenever possible, the same reference number will be used throughout the drawings to refer to the same or like parts.

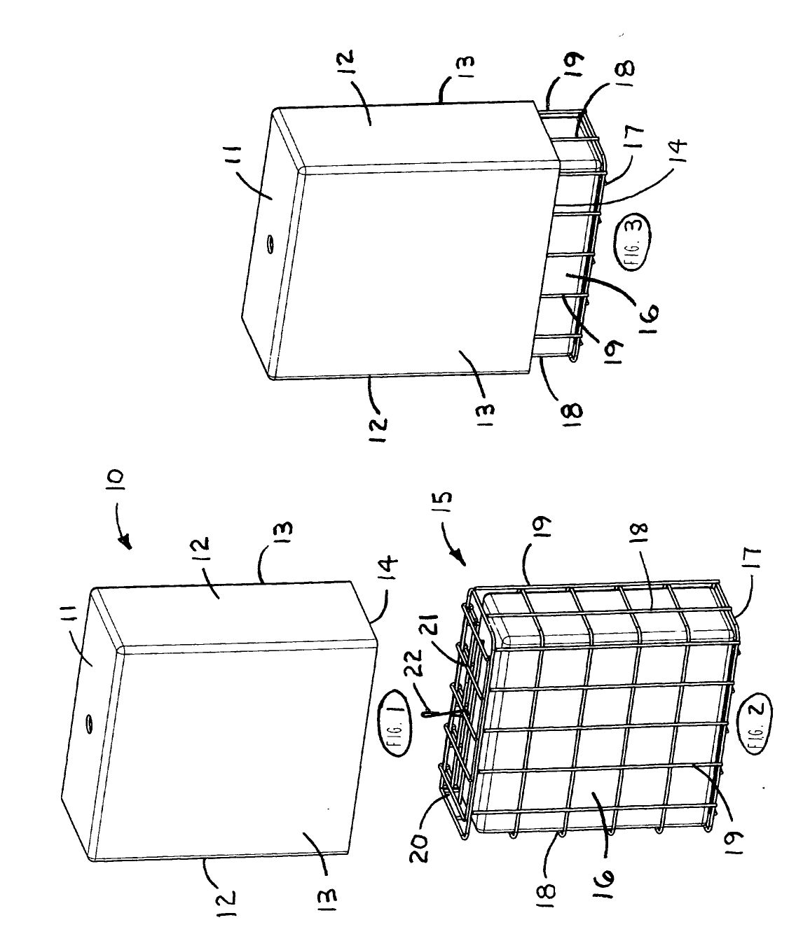

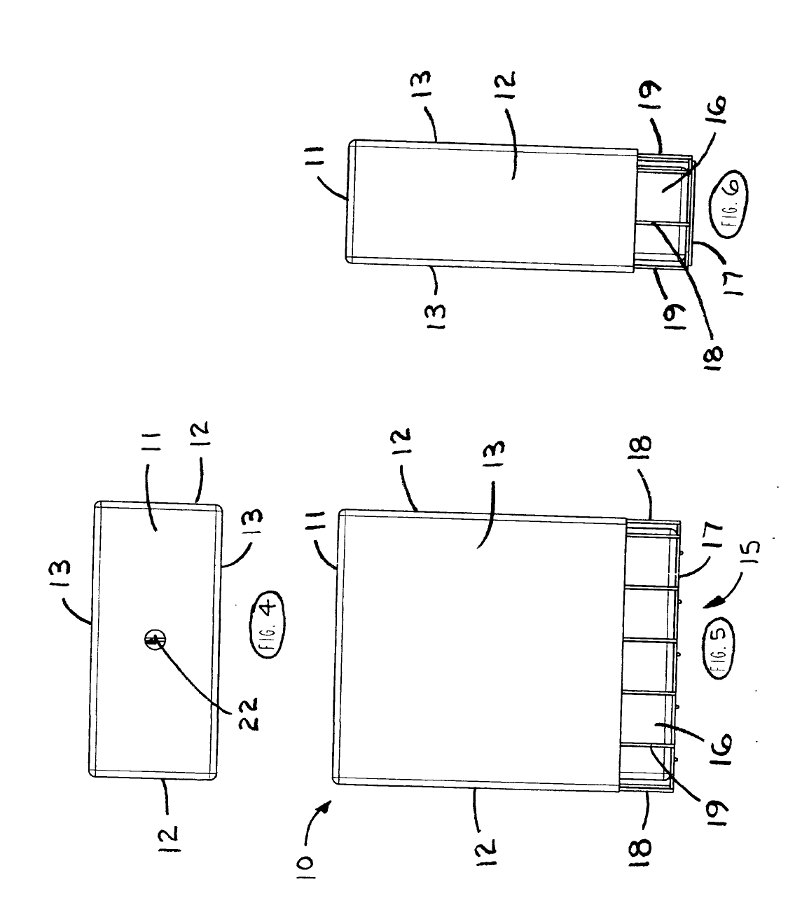

It is desirable to prolong the duration the solid bird food 16 will last and reduce the amount of unwanted type birds or animals. Such a function is provided by an enclosure 10 as shown in FIG. 1, when an enclosure 10 is used with a wire basket 15 that holds said food 16 the amount of exposure may be controlled by sliding the said basket 15 up or down in the enclosure 10. As an example the said basket 15 could be approximately 4″ wide by 5″ tall by 1″ deep and slide into the enclosure 10 allowing only one inch of exposure of the said food 16, this would allow approximately twenty percent of said food 16 to be exposed for consumption and approximately eighty percent to be concealed. And since the exposed area is reduced and less said basket 15 is exposed the unwanted type birds or animals are too large to attach onto said basket 15.

Referring now to FIGS. 1 thru 6, enclosure 10 includes a top 11, opposing sides 12, and opposing sides 13, defining a bottom opening 14. Allowing for access to the wire basket 15. Wire basket 15 includes a bottom 17, opposing sides 18, and opposing sides 19, defining a top opening 20. Allowing access to the solid bird food 16. Hinged cover 21 is attached to side 19 and retained by opposing side 19 to contain said food 16 in said basket 15. Wire hook 22 is attached to hinged cover 21 for an attachment point to hang said basket 15 from. Enclosure 10 shown could be constructed of elastomeric material such as rubber allowing said sides 12 and said sides 13 to expand when said basket 15 is inserted into the opening 14 of the enclosure 10 and create an interference with said basket 15 using friction to maintain location when the enclosure 10 is adjusted to a desired height for exposure of the solid bird food 16.

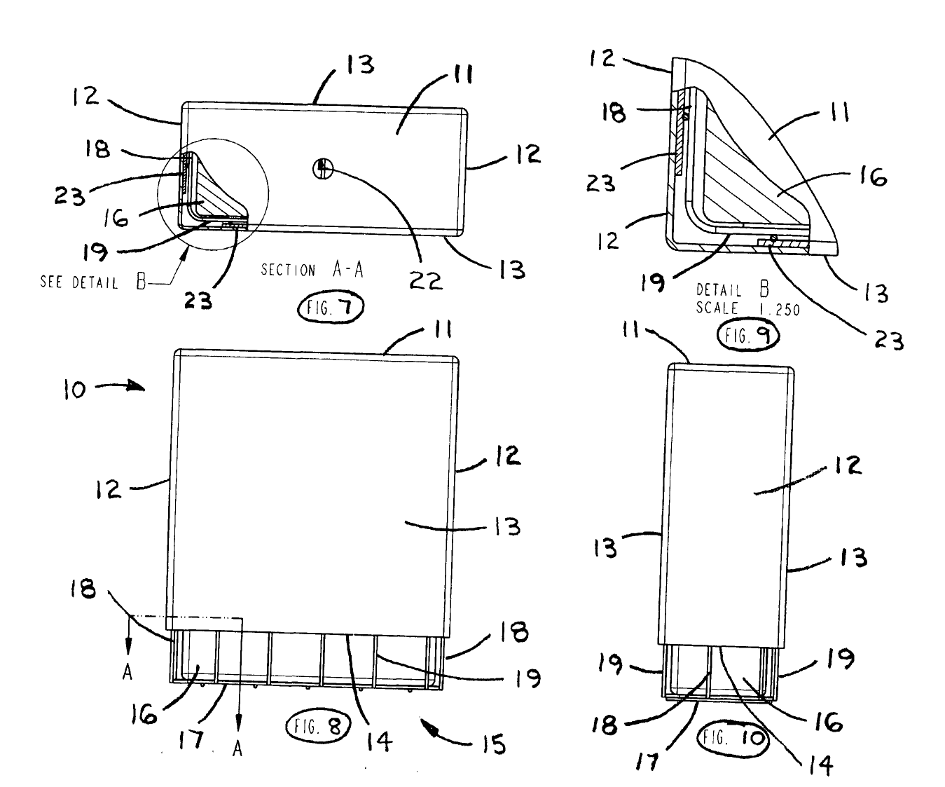

Referring now to FIGS. 7 thru 10, alternative enclosure 10 could be made of a rigid material such as plastic and allow for a non-interference fit with the wire basket 15. Pads 23 made of a elastomeric material such as rubber could be attached to the back side of opposing sides 12 and opposing sides 13 of enclosure 10 in multiple locations with a possible attachment method of adhesive to create a interference fit when said basket 15 is inserted into opening 14 of enclosure 10 using friction to maintain location when the enclosure 10 is adjusted to a desired height of exposure of the solid bird food 16.

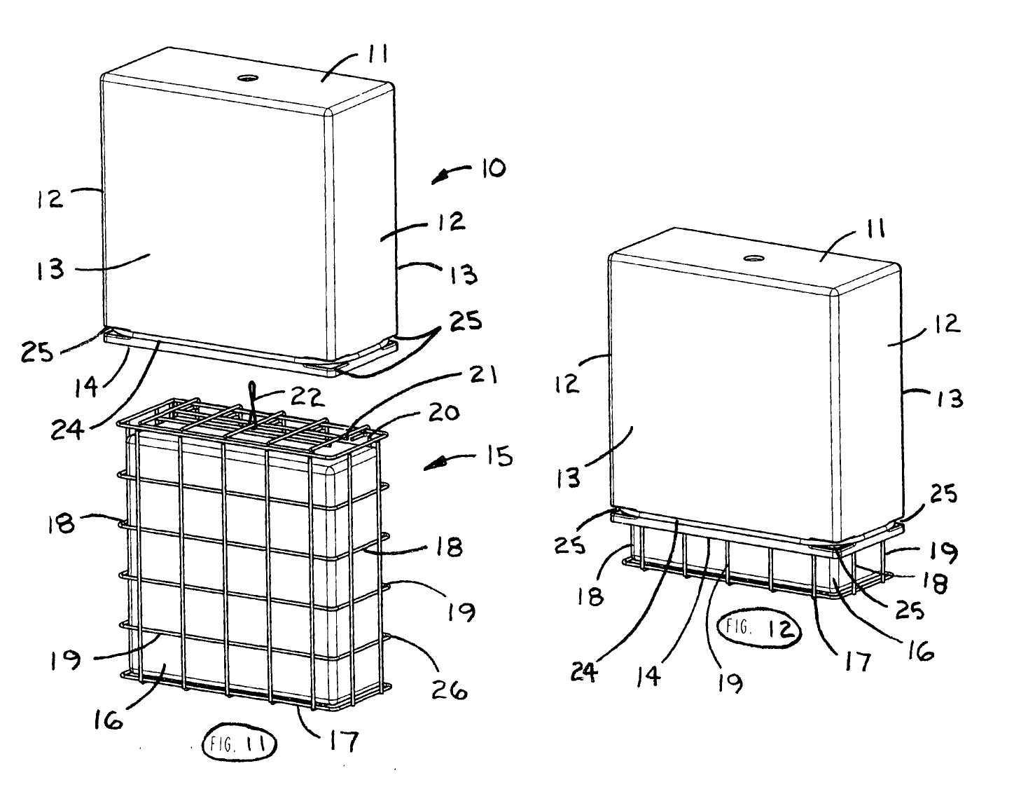

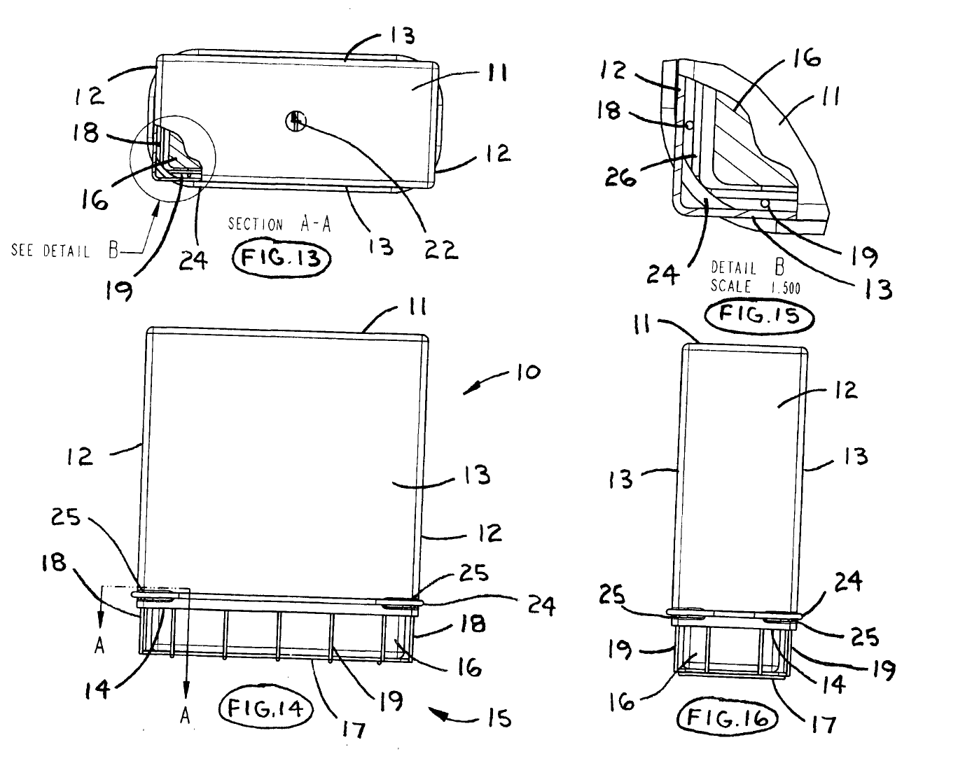

Referring now to FIGS. 11 thru 16, alternative method for adjusting the height of exposure of the solid bird food 16 could be mechanical. As an example enclosure 10 could be made of a rigid material such as plastic and allow for a non-interference fit with the wire basket 15. A component such as an o-ring 24 made of a elastomeric material such as rubber could be slipped over the outside of enclosure 10 and held into place by cutouts 25 located on each corner toward the bottom of enclosure 10. This would allow the enclosure 10 to be adjusted by increments determined by the spacing of each level of wire 26 on said basket 15 using a mechanical adjustment to obtain a desired height of exposed said food 16.

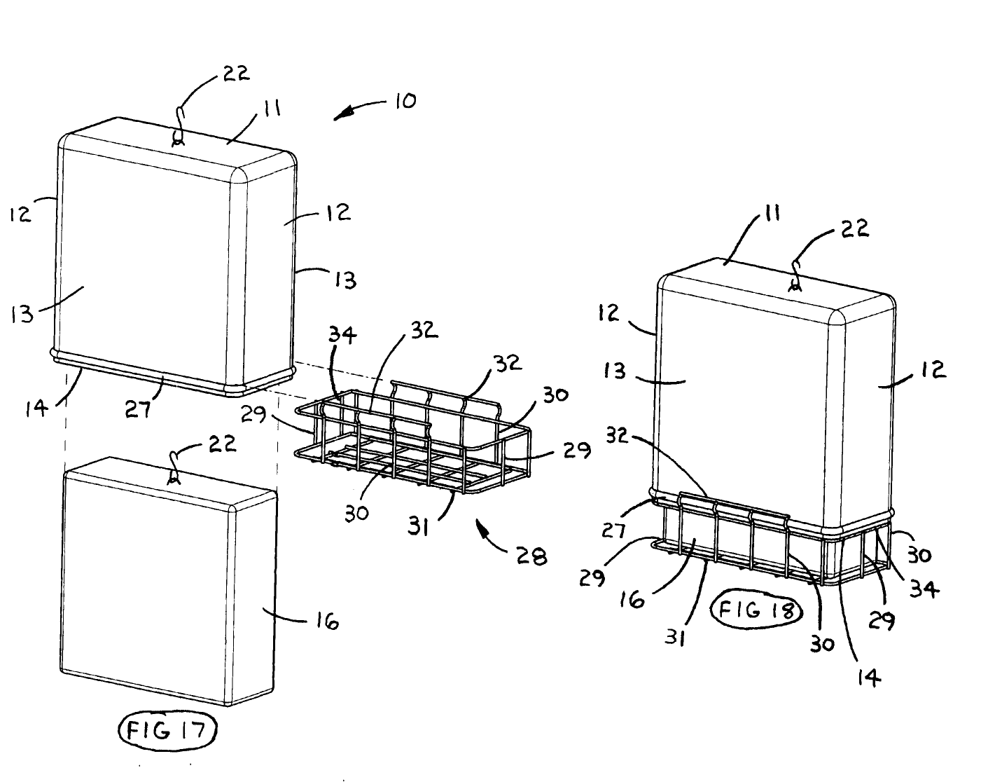

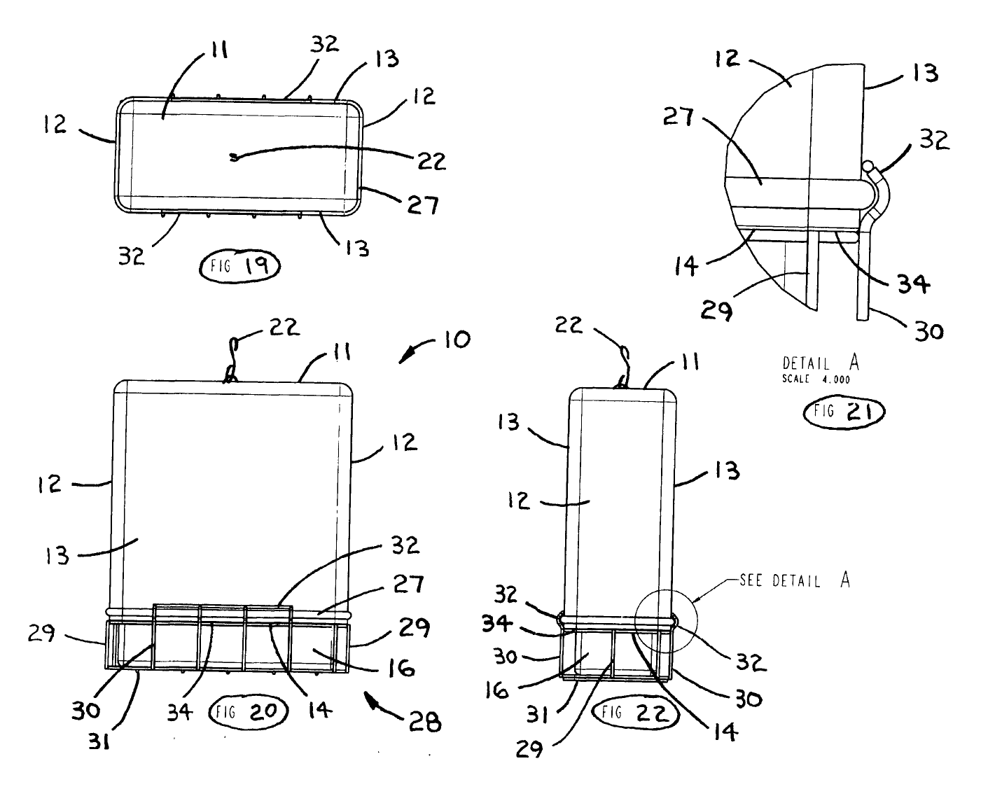

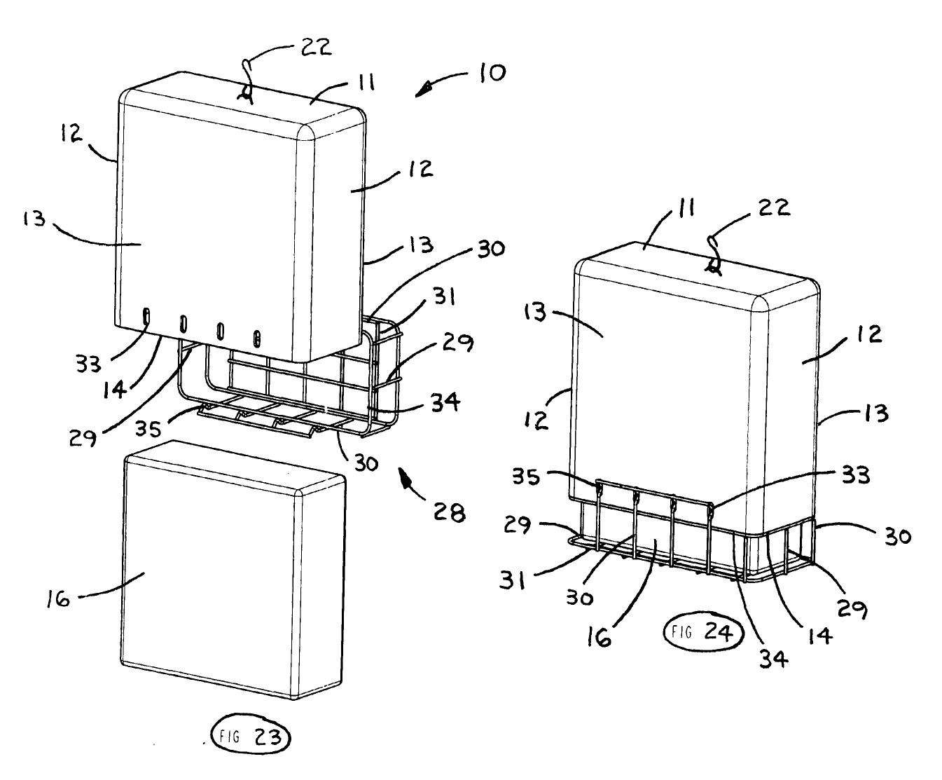

Referring now to FIGS. 17 and 22, alternative enclosure 10 could be made of a rigid material such as plastic and large enough to allow for the solid bird food 16 to freely slide in enclosure 10. Add a manufactured wire cover 28, wire cover includes a bottom 31, opposing sides 29, and opposing sides 30, defining a top opening 34 with a arc shape feature 32 attached to opposing sides 30 at top of opening 34 that would slide over a receiving protrusion 27 on both opposing sides 14 of enclosure 10. Could create an interference fit using friction with said feature 32 of said cover 28 and said protrusion 27 in said opposing sides 14 to retain said cover 28 in position when closed. The said cover 28 would allow a non-adjustable fixed amount of exposure of the solid bird food 16. Wire hook 22 is attached to top of enclosure 10 thru top surface 11 for attachment point to hang enclosure 10 from.

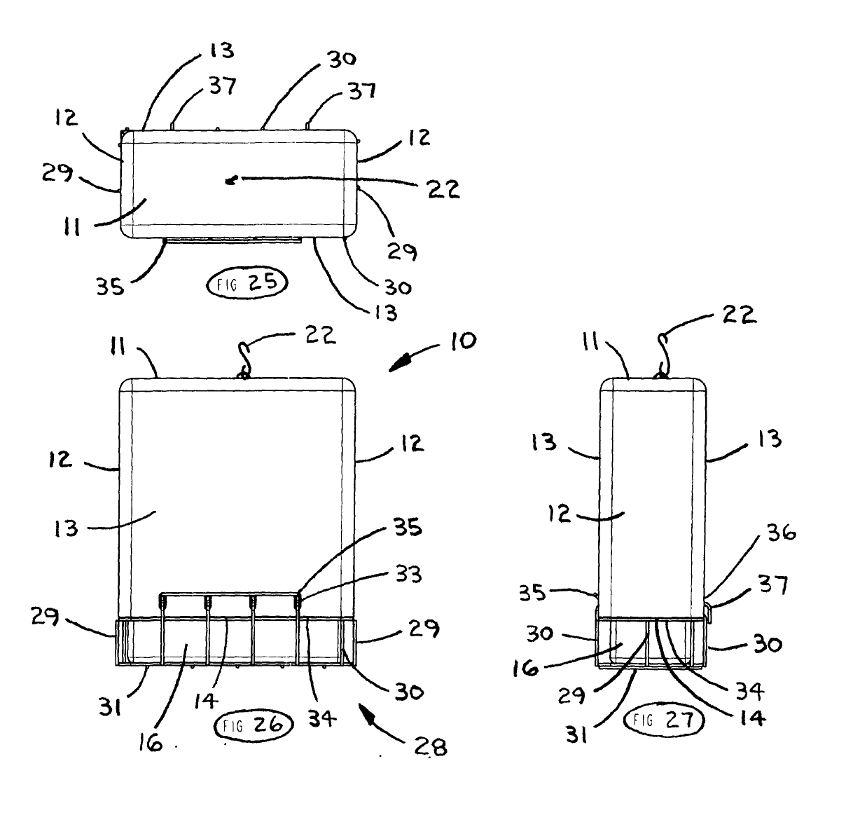

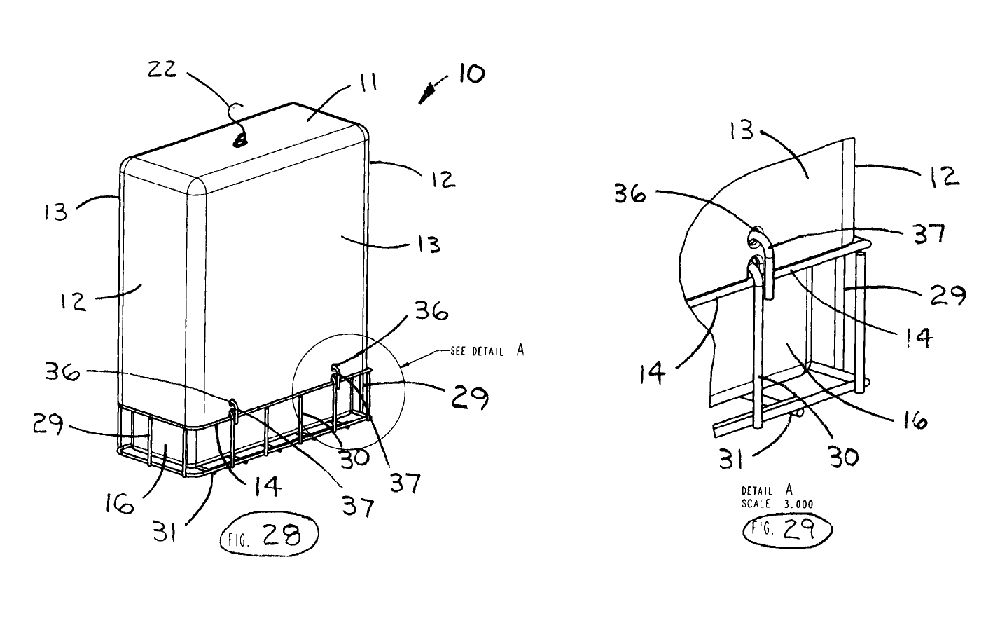

Referring now to FIGS. 23 and 29, alternative method for attaching wire cover 28. As an example the said cover 28 could attach to the enclosure 10 through created slots 36 next to bottom opening 14 of enclosure 10 on opposing side 13 to allow wire from said cover 28 to protrude and wrap around said side 13 to create a pivot 37. Allowing said cover 28 to rotate freely about the pivot 37. Opposing wall 13 could have slots 33 to allow the catch 35 on said cover 28 to engage into and lock said cover 28 into position. The said cover 28 would allow a non-adjustable fixed amount of exposure of the solid bird food 6.

With regard to the foregoing description, it is to be understood that changes may be made in detail, especially in matters of the construction material employed and the shape, size and arrangement of the parts without changing the scope of the present invention. It is intended that the specification and depicted aspects be considered exemplary only, with the true scope and spirit of the invention being indicated by the broad meaning of the following claims.

What is claimed is as follows:

1. A solid bird food enclosure which comprises:
an outer housing including four sides and top, leaving the bottom side open;
the side open to be sized to receive a wire basket
the depth to be defined by the depth of a wire basket.

2. The enclosure of claim 1, wherein the four sides are less than nominal of the wire basket.

3. A solid bird food enclosure which comprises:
an outer housing including four sides and top, leaving the bottom side open;
four cutouts on corners of sides to be sized to receive a elastomeric component
the side open to be sized larger than a wire basket
the depth to be defined by the depth of a wire basket.

4. The solid bird food enclosure of claim 3, wherein the depth of the cutouts will allow an elastomeric component when seated into the cutouts to set on top of a level of wire of a wire basket.

5. A solid bird food enclosure which comprises:
an outer housing including four sides and top, leaving the bottom side open, with bottom side open having receiving features;
the side open to be sized larger than a block of solid bird food
the depth to be defined by the depth of a block of solid bird food
a wire cover having four sides and a bottom, leaving the top side open.

6. The solid bird food enclosure of claim 5, wherein features on the wire cover are used to slide onto the receiving features on the enclosure to retain the wire cover, covering the open end when in a closed position.

7. A solid bird food enclosure which comprises:
an outer housing including four sides and top, leaving the bottom side open,
the side open to be sized larger than a block of solid bird food
the depth to be defined by the depth of a block of solid bird food
a wire cover having four sides and a bottom, leaving the top side open.

8. The solid bird food enclosure of claim 7, wherein the first end includes a pivot and the second end includes a catch, a wire cover engages and rotates about the pivot and is adapted to releasably engage the catch and being movable to an open position upon disengaging the catch.
